(19) United States
(12) Patent Application Publication
(10) Pub. No.: US 2003/0009498 A1
(43) Pub. Date: Jan. 9, 2003

(54) Method for digitally reordering and editing business stationery

(76) Inventor: Scott D. Koegler, Lake Worth, FL (US)

Correspondence Address: J. W. Gipple, GIPPLE & HALE, P.O. Box 40513, Washinton, DC, 20016, US

(21) Appl. No.: 09/875,106

(22) Filed: Jun. 7, 2001

Related U.S. Application Data
(60) Provisional application No. 60/209,345, filed on Jun. 5, 2000.

(51) Int. Cl. G06F 15/00

(52) U.S. Cl. 707/517; 707/520

(57) ABSTRACT

A method for digitally scanning an existing document containing text and/or graphic depiction (such as a business card, letterhead, or business forms), storing and editing the document and transmitting it to another location for reproduction.

This application claims priority based on provisional patent application serial No. 60/209,345.

### BACKGROUND OF THE INVENTION

The present invention relates to a method for digitally editing, storing and transmitting for reproduction, an image on a document. More particularly, the present invention relates to a method for digitally scanning an existing document containing text and/or graphic depiction, (such as a business card, letterhead, or business forms), storing and editing the document, and transmitting it to another location for reproduction.

When companies or individuals exhaust their supply of stationery or business cards, they generally turn to the original of source or some similar printing business. The standard procedure is to attach the existing stationery or business card to an order form and send it to the printer. This results in manually typesetting at the printer's plant and subsequent proofreading to assure that the typesetting is accurate in copying the original design.

It is, therefore, an object of this invention to provide an enhanced method for digitally editing and reordering documents such as business cards, letterhead and other business forms. It is a further object of the invention to provide an expedited method for re-ordering documents that avoids manual typesetting and proofreading by the printer.

### SUMMARY OF THE INVENTION

Accordingly, the present invention is directed to an enhanced method for obtaining and re-ordering documents that substantially avoids one or more of the disadvantages of prior art techniques.

To achieve these and other advantages and in accordance with the purpose of the invention as embodied and broadly described, the present invention comprises:

electronically scanning an image printed on an original document, such as a business card or letterhead, to produced a digitalized signal;

electronically reproducing the signal on a screen from the digitalized signal and analyzing and editing the reproduced signal to produce an edited signal;

electronically storing the edited signal in a data base;

retrieving and electronically transmitting the edited signal from the data base to a remote location;

retrieving the transmitted signal at the remote location and reproducing the edited image from the signal on reproduced documents.

### DETAILED DESCRIPTION OF A PREFERRED EMBODIMENT OF THE INVENTION

Reference will now be made to an exemplary embodiment of the present invention which comprises the user scanning the document and viewing the results of the scanning on a computer screen. The user can then correct errors or make changes and see the document recomposed with the changes effected. The user can then send an order through the internet to the printer's email address where an online processing system fills the order. This method effectively changes the traditional paper based order process to a digital process and eliminates several steps required with the paper-based order process. By doing this, the time to create an acceptable order is reduced to approximately 5 to 10 minutes. This compares to the paper-based ordering process that can take up to 2 days when sent by either fax, courier, or mail and subsequent proofs need to be reviewed before the final print is approved. This is because the user performs the proofing process online before sending the order to press.

Principal steps of the new method of the invention are as follows:

1. Scan and interpret a document (e.g. a business card) in the manner currently in place using commercially available document scanning and interpreting applications.

2. Determine the X/Y position of the baseline of each scanned line of text and store that information with the data.

3. Identify the font of each line of text.

4. Analyze the point size of the font on each line of text. Text can be scanned in B&W, using a standard scanning device.

5. Identify any logos (or other such graphics not subject to optical character recognition) and scan them as color scans. These are cropped to their nearest dimensions. User interaction in this process is contemplated to assist in determining the bounds of the image.

6. Determine the X/Y coordinates (top left and bottom right) of the image at its scan area and store that data.

The resulting data and scans is stored in a database. This data is then passed to the editing and composition utilities for further processing.

Exemplary steps are illustrated in greater detail on the flow diagram that follows.

In the flow diagram, several abbreviations and acronyms are used to conserve space. CS refers to the invention, itself which applicant calls a “Card Scope.” B&W means black and white. OCR stands for “optical character recognition.” BCT refers to the printer or printing company. OPC identifies a web-site address such as “Order Printing.Com”

It will be apparent to those skilled in the art that various modifications and variations can be made in the method of the present invention without departing from the spirit or scope of the invention. Thus, it is intended that the present invention cover the modifications and variations of this invention provided they come within the scope of the appended claims and their equivalents. It will further be apparent that the present invention contemplates the editing and reproduction of a wide variety of documents susceptible to electronic scanning, storage and editing, and is not limited to those documents provided herein by example.

[image]

[image]

[image]

[image]

[image]

What is claimed is:

1. A method for digitally storing, transmitting and reproducing an existing image on a document comprising:
electronically scanning an image printed on an original document to produce a digitalized signal;
electronically reproducing said image from said digitalized signal and analyzing and editing said reproduced image to produce an analyzed, edited signal;
electronically storing said analyzed, edited signal in a database;
retrieving and electronically transmitting said edited signal from said database to a remote location;
retrieving said transmitted signal at said remote location and reproducing said edited image from said signal on reproduced documents.

2. The method of claim 1 wherein said image comprises text and graphic depictions which are electronically scanned, analyzed and edited, stored, transmitted and retrieved, and reproduced.

3. The method of claim 2 wherein the baseline, font and point size at each line of said text is determined and stored in said database.

4. The method of claim 2 wherein said graphic depictions are color scanned and stored in said database.

5. The method of claim 4 wherein said scanned graphic depictions are electronically reproduced, analyzed and cropped to an appropriate dimension prior to storing in said database.

6. The method of claim 4 wherein said graphic depictions are logos.

7. The method of claim 5 wherein said graphic depictions are logos.

8. The method of claim 1 wherein said original document is selected from business cards, letterhead, labels, billing forms and ordering forms.

9. The method of claim 1 wherein said reproduced documents are essentially multiple copies of said original document.

10. A method for electronically storing, editing and transmitting an image on a business card, letterhead or business form comprising:
electronically scanning said image printed on an original document to produce a digitalized signal;
electronically reproducing said scanned image on a screen;
analyzing and editing said scanned image and storing the edited image in a database;
retrieving and electronically transmitting said edited image from the database to a remote location;
retrieving said transmitted signal at said remote location and reproducing the edited image from said signal on reproduced documents.

11. The method of claim 10 wherein said image comprises text and graphic depictions which are electronically scanned, analyzed and edited, stored, transmitted and retrieved, and reproduced.

12. The method of claim 3 wherein the baseline, font and point size at each line of said text is determined and stored in said database.

13. The method of claim 2 wherein said graphic depictions are color scanned and stored in said database.

14. The method of claim 5 wherein said scanned graphic depictions are electronically reproduced, analyzed and cropped to an appropriate dimension prior to storing in said database.
